(19) United States
(12) Patent Application Publication
(10) Pub. No.: US 2026/0125849 A1
(43) Pub. Date: May 7, 2026

(54) LEATHER-LIKE MATERIAL OF VEGETABLE ORIGIN MADE FROM PERSIMMON PUREE

(71) Applicant: PERSISKIN, S.L., Carlet, Valencia (ES)

(72) Inventors: Jaime SANFÉLIX PALAU, Carlet, Valencia (ES); María VLADAN, Carlet, Valencia (ES)

(21) Appl. No.: 19/119,704

(22) PCT Filed: Oct. 11, 2022
(86) PCT No.: PCT/EP2022/078268

§ 371 Date: Apr. 9, 2025

(51) Int. Cl. D06N 3/14; D06N 3/00; D06N 3/18

(52) U.S. Cl. CPC D06N 3/145; D06N 3/0077; D06N 3/183; D06N 2213/03

(57) ABSTRACT

The present invention relates to a vegan and reusable leather type material of vegetable origin, at least 50% and preferably at least 80% biobased. This material is based on a composition which comprises persimmon (Diospyros kaki) mass and a polymer derived from a polyol of vegetable origin. The invention also discloses the process for obtaining the material. The leather-type material may be used in a variety of goods products in the textile such as clothes, footwear products or accessories. The material has proven to keep the same mechanical properties as the animal origin or synthetic leather, being a sustainable alternative which, in addition, contributes to circular economy. The sustainable material, leather-type of vegetable origin, provides an alternative to known leathers, with less environmental impact.

### FIELD OF THE INVENTION

The present invention relates to the provision of a natural, eco-friendly, vegan, and reusable leather type material of vegetable origin. This material may be used in a variety of goods products in the textile field in substitution of leather of animal or synthetic origin.

### BACKGROUND OF THE INVENTION

People are already using materials derived from animal skin since long time ago. This material is preferred because of advantages such as strength, flexibility, durability, and attractive appearance. Animal skin can be applied into various kinds of consumer products, such as clothing, furniture, vehicle interiors, and many other retail products. Many issues are often associated with the production of animal skin are related to environmental, health or social issues (Sivaram and Barik, 2019. Energy from toxic organic waste for heat and power generation. Chapter 5. Woodhead Publishing Series in Energy. Pages 55-67). Animal production used as raw material for leather production requires high water, energy, and land, making production of livestock produce large greenhouse gases (CO2 and NH4). Production of animal skin also requires a large mixture of chemicals (such as chromium salts and dyes from heavy metals), which have impact on the environment since it requires a lot of water, has the potential to pollute and also has toxic and carcinogenic properties that can be harmful to human's health and the environment when it is scattered.

The use of animal skin and fur is also being a concern of the society. Many people are against the use of animal skin and fur because they are considered unethical. With the increasing demand for stopping the use of animal skin, it is necessary to find alternative substitutes. One of the options that is considered more environmentally friendly is synthetic leather. In recent concerns over sustainability in any field of industrial production have led to a pressing rationale to enhance the use of natural materials and replace non-renewable fossil-based raw materials. Although leather is bio-based and renewable, these considerations did not lead to a renaissance of leather. Instead, leather got even more under pressure due to ongoing discussions over the greenhouse gas emission of cattle breeding, the sustainability of leather production, and animal welfare. At the same time, an increasing number of people want to eat consciously meat-free or to do without any products of animal origin entirely. All these needs pose new challenges in culture and material development.

Vegan leather refers to a leather with no animal presence in any of its processes. This type of leather is usually leatherette, that is, synthetic leather. It is vegan, because it is not of animal origin, but it incorporates plastics, therefore, it is not ecological. This synthetic leather material is usually made from polyvinyl chloride (PVC) and polyurethane, petroleum-based products. Even though synthetic leather may provide a solution to the problems of animal skin production processes, PVC-based synthetic materials have not been able to solve environment problems. Raw materials derived from petroleum are not sustainable and the process of producing it uses additional chemical compounds such as plasticizer to make synthetic leather more elastic. Moreover, tanning leather has also a high environmental impact. None of the vegan leather created so far is fully biodegradable yet. That is because each material is either made with a mix of plants and polyurethane or is plant-based and coated with a plastic-based resin. An environmentally friendly leather substitution with an attractive appearance to consumers is needed.

Vegetable leather is an alternative material to animal leather, which is produced from different components and waste, always of vegetable origin, and which becomes the most sustainable alternative to traditional animal skins, beyond other products and synthetic materials. There are vegetable leathers from mushrooms, pineapple, paper, waxed cotton, teak leaves, apple fibers, grapes, kombucha tea, corn, cereals, coconut, hemp, white nettle or cork. However, the leather made by these vegetables usually includes synthetic material. However, in order to improve structural features and an appearance attractive to the consumer, this leathers usually comprise synthetic polymers ingredients such as polyurethane.

Circular economy is an economic system aimed at eliminating waste and the continual use of resources. Circular systems employ the basic principles reuse, sharing, repair, sharing, refurbishment, remanufacturing and recycling to create a closed-loop system, minimizing the use or resource inputs and reduce the creation of waste, pollution and carbon emissions. It is estimated that one third of food for human consumption is lost or wasted globally, which is equivalent to 1.3 billion tons per year. The food loss and waste have become an issue of great concern nowadays. For this reason, in the 2030 Agenda for the Sustainable Development the United Nations reflects a greater awareness of this problem and proposal of measures by companies in order to reduce the food waste.

The leather goods produced of vegetable origin, despite being a natural alternative to synthetic leather and leather of animal origin, usually are obtained from crops produced ad hoc for this purpose, which is not sustainable and may even affect the natural environment.

Spain is the most important European country in the cultivation of persimmon, with a total area of 18,601 hectares and a production of 492,320 tons. Currently, Spain is the second largest producer of persimmon worldwide, accounting for 10.4% of total persimmon production. In Spain, according to 2017 data from the Spanish Ministry of Agriculture, the Valencian Community has 15,931 hectares of persimmon cultivation. This represents 86% of the national area and produces 384,785 tons of the total production in Spain, representing 95% of the total. In less than ten years, the area of persimmon in the Valencian Community has multiplied by six its cultivation area, from 2,000 ha to more than 13,000 ha. Due to its great characteristics and the area in which it is grown, the “Kaki Ribera del Xúquer” is the only persimmon recognized and with Protected Designation of Origin worldwide (Persimmon®). Unfortunately, due to the market demands and the potential presence of pests and diseases, almost half of the harvest is wasted each year. The total mass and economic losses of persimmon producers were estimated to be 29.5% (referred to the total produced volume) or 38.5% (referred to the number of final commercialised kilograms) on average. Therefore, millions of kilograms of persimmon potentially edible are wasted every year.

There is a need in the prior art for a leather of vegetable origin, biodegradable, natural, eco-friendly, compostable, vegan, and reusable, which do not contain synthetic material and do form part of the circular economy of the starter material origin region.

### DESCRIPTION OF THE INVENTION

The present invention discloses a vegan leather-type material of vegetal origin comprising persimmon. The present invention has been developed from a Circular Economy project developed in the University of Valencia Science Park, Spain. The residues of persimmon and specimens which would have been thrown away, are reused in the manufacturing of leather. With the process disclosed herein there are no residues left.

In a first aspect, the present invention refers to a composition for vegan leather comprising persimmon (Diospyros kaki) and a polymer derived from a polyol of vegetable origin. In a preferred embodiment, the persimmon may be selected from Bright Red (“Rojo brillante”) or Triumph varieties. In a more preferred embodiment, the ingredient is persimmon Bright Red (“Rojo brillante”) variety.

The persimmon mass for the composition of the invention is selected from persimmon extract, persimmon puree, persimmon pulp or a combination thereof. In a preferred embodiment, the persimmon mass is persimmon puree or persimmon extract. The puree may be obtained by blending and mashing the fruits by any known method in the art. The persimmon extract may be the result of a Soxhlet extraction of persimmon fruits. The fruit pieces or the persimmon puree may be frozen after step a). In an embodiment, the persimmon mass is incorporated directly to the process without having been frozen.

Leather is commonly defined as the skin of an animal treated in order to preserve it for use in the manufacture of goods such as clothes, shoes, etc. For the purpose of the present invention, the expression “leather-type material” or “vegan leather” refers to a product which resembles leather of animal origin and may be used for the manufacturing of the same consumer goods as leather. Vegetal or vegan origin refers to a biogenic raw material from biological precedence (an organic material which is or is produced directly by the physiologic activities of plants instead other elements such as fossil gas, coal, or petroleum).

In the present invention, it is also used the expression “biobased” to refer to products that mainly consist of a substance (or substances) derived from living matter (biomass) and either occur naturally or are synthesized, or it may refer to products made by processes that use biomass. Biobased materials are perceived as potentially greener alternatives than their petroleum-based counterparts. (United States Environmental Protection Agency, EPA). This term is widely extended, in fact there is an international labeling system to classify materials as biobased according to the percentage of renewable raw materials (% Bio-based). Any ingredient 100% or vegetal origin would be also 100% biobased. Further definitions of bio-based products may be found at https://single-market-economy.ec.europa.eu/sectprs/biotechnology/bio-based-products_en

Preferably, the composition comprises between 20-60% wt. in respect of the total weight of the composition and/or the polymer represents between 40-80% wt. in respect of the total weight of the composition. More preferably, the composition comprises persimmon represents between 30-40% wt. in respect of the total weight of the composition and/or the polymer represents between 60-70% wt. in respect of the total weight of the composition.

In one embodiment, the composition of the invention comprises persimmon and a plasticized starch derived from starch and a polyol of vegetable origin The starch is selected from the group consisting of corn, tapioca, potato or combinations thereof, preferably the starch is corn starch. The polyol is selected from the group consisting of glycerol, erytritol, ribitol and xylitol, preferably, the polyol is glycerol.

In another embodiment, the composition of the invention comprises persimmon and a polymer which is a polyurethane derived from vegetable polyols.

In the present invention, the term “polyurethane or PU derived from vegetable polyols” refers to a PU obtained by the reaction of polyisocyanates and polyols based on vegetable oils such as soy, safflower, cotton, linseed, peanut, olive, sunflower, canola, rapeseed, corn, palm oil or combination thereof. Non-limiting examples of said PU may be found in US20060276609A1 and non-limiting examples of vegetable oil-based polyols in U.S. Pat. No. 7,786,239B2.

In a preferred embodiment, the present invention provides a composition for vegan leather type material of vegetal origin comprising:
40-60% of persimmon red brilliant (“Rojo Brillante”);
10-40% w/w of corn starch and
2-20% w/w glycerol.

In a more preferred embodiment, the material comprises about 59% w/w of persimmon red brilliant (Rojo Brillante), about 27% w/w of corn starch and about 14% of glycerol. The term “about” should be interpreted as a margin of ±2% w/w.

The composition may further comprise a plant-derived dye. The dye provides the desired colour to the final product. In a preferred embodiment 1-2% wt. in respect of the total weight of the composition of dye is present. In a preferred embodiment, the amount of dye is 0.1-1% wt. The dye may be selected from any vegetal origin dye, such as dyes from cutch tree, gamboge tree resin, chestnut hulls, Himalayan rhubarb, Indigofera leaves, kamala seed pods, madder root, mangosteen peel, myrobalan fruit, pomegranate rind, teak leaf, weld herb or charcoal among others. In a preferred embodiment, the dye is charcoal.

In a preferred embodiment, the composition of the invention further comprises between 1-10% wt. in respect of the total weight of the composition of a vegetal oil selected from sesame oil, canola oil, sunflower oil, soybean oil, peanut oil, olive oil, corn oil, bean oil, grapeseed oil, jojoba oil, palm oil, cotton seed oil, almond oil, safflower oil, walnut oil, avocado oil, rice bran oil, and flaxseed oil.

In another preferred embodiment, the composition of the invention further comprises between 0.5-2% wt. in respect of the total weight of the composition of an additive selected from thickeners, crosslinkers, stabilizers. These additives are the commonly known by the skilled person in the field of polymers.

Another aspect of the invention refers to a vegan leather material comprising the composition based on persimmon as described above.

In a preferred embodiment, this material is a layered material comprising the following layers:
a) a top layer comprising waterborne polyurethane,
b) a second layer comprising the composition according to claims 1-9,
c) a third layer comprising a waterborne polyurethane with adhesive properties, and
d) optionally, a fourth layer which is a textile layer.

The waterborne polyurethanes to obtain this layered material of the invention may be anyone known in the art. It may be used in the form of dispersions which are a binary colloidal system in which the polyurethane particles are dispersed in a continuous aqueous medium. The concept of producing water-based polyurethanes is directed toward producing polymers with a high number of hydrophilic groups to obtain water solubility. The characteristics of these waterborne polyurethanes has made them highly suitable for a wide range of applications. These environment-friendly polymers are non-toxic, nonflammable, plus they do not pollute the air or produce wastewater. As only water evaporates during the process, these systems are not harmful to the environment. Waterborne polyurethanes are important in many industrial applications such as coatings, adhesives, ink binder, glass fibers, paper sizing, synthetic leathers, biomaterials, membranes, and films for packaging, and waterproof textiles.

In another preferred embodiment, the layer (a) represents between 10-20% wt. in respect of the total weight of the material, and/or the layer (b) represents between 20-70% wt. in respect of the total weight of the material, and/or the layer (c) represents between 2-10% wt. in respect of the total weight of the material and/or the layer (d) represents between 30-50% wt. in respect of the total weight of the material.

In another embodiment, the top layer (a) of the material is coated with a composition comprising a wax and a vegetable oil, preferably in a 1:1 ratio. The wax may be selected from bee wax, carnauba wax, montan wax or candelilla wax, preferably bee wax. The oil may be selected from any vegetable oil, such as sesame oil, canola oil, sunflower oil, soybean oil, peanut oil, olive oil, corn oil, bean oil, grapeseed oil, jojoba oil, palm oil, cotton seed oil, castor oil, almond oil, safflower oil, walnut oil, avocado oil, rice bran oil, and flaxseed oil. Preferably, the vegetable oil is olive oil.

The top layer (a) is formed from a waterborne polyurethane, deposited onto the layer (b) of the composition comprising persimmon. In a preferred embodiment, the polyurethane 10-20% wt., preferably about 17% wt. in respect of the total weight of the layered material. Preferably, the polyurethane layer is at least 45% biobased.

The second layer (b) is formed from the composition comprising persimmon previously described and may be adjusted by amending the percentages of its components, in order to vary the softness, flexibility and mechanical resistance of the final material. This layer constitutes a 20-70% wt., preferably about 50% wt. in respect of the total weight of the layered material.

The third layer (c) is an adhesive layer located between the second layer (b) and the textile layer. In a preferred embodiment, the adhesive is 2-10% wt., preferably about 7.5% wt in respect of the total weight of the layered material. Preferably, the adhesive layer is at least 50% biobased. In a preferred embodiment, the adhesive is waterborne polyurethane adhesive. The polyurethane and the adhesive may be any ingredient (polyurethane or adhesive respectively) with the requirement of being solvent free with high percentage of bio-based material. Non-limiting examples of this polyurethanes may be found in EP2554559B1.

The textile layer is preferably made from vegetal fibres and has a mechanical support function. This layer may be selected among any textile consisting of 100% vegetal origin, such as cotton, seed, coconut, linen or the same. In a preferred embodiment, the textile layer is 100% cotton. The textile layer is 30-50% wt., preferably about 37% wt., in respect of the total weight of the layered material.

The layered material of this embodiment has the following structure, from top to bottom: polyurethane, material comprising persimmon, adhesive and 100% textile layer.

In a preferred embodiment, the width of each layer is: the layer (a) has a thickness of 0.05-0.30 mm, and/or the layer (b) has a thickness of 0.20-1.50 mm, and/or the layer (c) has a thickness of 0.05-0.20 mm, and/or the layer (d) has a thickness of 0.20-0.50 mm. The final material has a width of about 0.6-2.5 mm. The term “about” should be interpreted as a margin of ±2% of the values indicated above.

The layered material must be at least 50% biobased, preferably at least 80% biobased and more preferably at least 85%.

Any of the leather-type materials of the invention disclosed above has an aspect and mechanical features which resemble to animal origin or synthetic leather. Mechanical properties such as single tear strength, tensile strength, rub fastness, flexibility and mean thickness of the materials of the invention are comparable to leather materials of the prior art, which means that they are suitable to be used as a replacement for these materials. Demonstrations of these properties will be exposed in the examples.

In a third aspect, the present invention refers to a process for obtaining the layered material previously described comprising the following steps:
a) depositing a first layer of waterborne polyurethane onto a support;
b) drying the polyurethane of step a) at a temperature between 100-120° C. for 1-10 minutes;
c) adding to the dry polyurethane of step b) a layer of the composition comprising persimmon previously described;
d) drying of the two layers at a temperature between 70-150° C. for 5 minutes to 2 hours;
e) adding a third layer of waterborne polyurethane with adhesive properties on the layer comprising persimmon dried in step d), and optionally adding a textile layer above the adhesive layer of step e);
f) drying at a temperature between 100-150° C. for 1-5 minutes.

With the aim of imitate the aspect of leather onto the top layer of the vegan leather material of the invention, the support of step a) where the first layer is deposited presents a pattern to impress said pattern onto the top layer (a). This may be done with an embossing paper, which will define the surface design of the material. Any embossing paper may be used, although an embossing paper imitating the appearance of leather of animal origin is desired. Other option is applying ironers with the desired pattern and pressing onto the top layer to give it this imitation shape.

For the embodiment in which the composition of persimmon comprises a polymer derived from starch, starch is dissolved in distillated water and heated. In a preferred embodiment, the starch is in the form of starch granules. The solution is continuously stirred and heated at a temperature between 70-80° C. until the starch is completely dissolved. It is important that the starch molecules are dispersed in heated water in order to avoid the crystallinity of the starch via gelatinization. The temperature range is important since a temperature between 70 and 80° C. avoids starch degradation. The melting temperature of native starch lies above the decomposition temperature. With a temperature above this range, the starch may lose the equilibrium moisture inside its granules, and it starts to degrade before being dissolved. The starch may be selected from the group consisting of corn, tapioca, potato or combinations thereof. In a preferred embodiment, the starch is corn starch. In a more preferred embodiment, the starch is starch granules of corn. The amount of starch is 5-20% w/v, preferably 10-20/w/v and more preferably 16% w/v in relation to the distillated water.

For purposes of the present invention, the expressions “thermoplastic starch”, “plasticized starch”, “pseudo thermoplastic starch” are equivalents and refer to a uniform material formed by the gelatinized starch combined with a polyol. In a first stage, a polyol, preferably of vegetal origin, is added to the gelatinized starch and in a second stage, the mixture is heated at 70-80° C. until a translucent gel phase is formed in continuous stirring. The amount of polyol is the 40-60% w/w of the amount of starch added in step b), preferably 50% w/w. In a preferred embodiment, the polyol is selected from the group consisting of glycerol, D-sorbitol, galactitol, mannitol, pinitol, arabitol, ribitol, erythritol, threitol, cylitol, volemitol, perseitol and meso-Inositol. In a more preferred embodiment, the polyol is glycerol. The polyol form hydrogen bonds with the starch molecules, which take the action of the hydroxyl groups of the starch molecules, increasing their molecular mobility and make the starch displays plasticization. It is necessary that all the granules of starch have to completely turn into a translucent gel phase to form the pseudo thermo-plastic starch. In a preferred embodiment, the glycerol (CAS number 56-81-5) in step c) is of vegetal origin. It may be obtained from heated coconut, soy, or palm oil under pressure with water, so that the glycerol splits off into the water. The glycerol is then isolated by distillation. Glycerol may be also obtained as a by-product from soap or biodiesel manufacturing. Glycerol is also a waste product from biodiesel production, therefore using glycerol from this process, also improves sustainability of the process of the invention (Gu Y and Jerome F, 2010. Green Chemistry 12; 1127-38). The combination of water and glycerol enhance the flexibility of the material by increasing the intermolecular spacing and reducing the intramolecular hydrogen bonding along the starch polymer chains.

Then, 20-40% w/v of the persimmon mass is incorporated into the thermoplastic starch of step. In a preferred embodiment, the amount of persimmon mass added is 20-25% w/v. The mixture is stirred until a homogeneous substance or composite is formed. The persimmon mass act as a binder in the mixture, forming a composite. Persimmon as binder improves the rigidity of the material, avoiding the polymer become too brittle as water is lost and also improving the thermoplastic properties of the starch. This combination is blended until complete homogenization.

In another embodiment, a plant-derived dye may be added in the previous step. The dye provides the desire colour to the final product. In a preferred embodiment, 0.1-1% w/v of dye is added to the mixture. In a more preferred embodiment, the amount of dye is about 0.5% w/v of the mixture. The dye is selected from any vegetal origin dye, such as dyes from cutch tree, gamboge tree resin, chestnut hulls, Himalayan rhubarb, Indigofera leaves, kamala seed pods, madder root, mangosteen peel, myrobalan fruit, pomegranate rind, teak leaf, weld herb or charcoal among others. In a preferred embodiment, the dye is charcoal. Charcoal is a vegetal dye stable at high temperatures, light and pH and it can also provide antibacterial resistance to the leather obtained by the process disclosed before. Activated carbons such as charcoal remains stable up to far above 900° C.

Later, the homogenized composite is placed between a mold and a sheet of 100% cotton fibre material. The mold determines the design of the material. In the present case, a mold resembling the surface of animal-origin may be used. The material is incorporated on the mold forming a layer of 3-10 mm. A sheet of 100% cotton fibres is put on the layer of composite. This sandwich structure is under a curing process, which consists of introducing the structure in an oven and heating between 6° and 80° C., preferably at about 70° C. for 1-20 hours, preferably 1.5-4 hours. After this curing step, the material is maintained at room temperature from 12 to 24 hours. This cooling time at room temperature would depend on the curing time of step e), the lower the curing, the lower the resting time. Once the resting time has elapsed, the sheet of material is taken out from the mold, and the leather-like material is obtained. The size of the sheet of this material depends on the size of the mold, and its thickness after step e) is approximately 0.6 to 2.5 mm.

The composition of the homogenised composite in step e) comprises 20-40% w/v of persimmon, 5-20% w/v of starch, 2-12% v/v of glycerol and 28-73% v/v of water, percentages referred to the final amount of homogenised composite. In a preferred embodiment, the homogenised composite in step e) comprises 20-25% w/v of persimmon, 7-15% w/v of starch, 3-6% w/v of glycerol and 54-70% v/v of water, percentages referred to the final amount of homogenised composite. In a more preferred embodiment, the homogenised composite also comprises 0.1-1% w/v of a dye of vegetable origin.

To coat the top layer of the layered material, the wax and the oil are heated and mixed. This formulation is cooled down at room temperature and applied on the material obtained in step e). The coated material is introduced in an oven and heated at 60-80° C., preferably at 70° C. for 2-10 minutes. An additional layer of coating may be added, repeating the same process described herein.

In another embodiment, the leather-type material is further reinforced with a bacterial or yeast culture by SCOBY (symbiotic culture of bacteria and yeast). SCOBY is a biopolymer obtained from the fermentation of Kombucha beverage produced by tea (Black tea/Green tea) and sugar fermentation. The layer of SCOBY obtained after the fermentation of Kombucha can be added on top of the dried leather or in the formulation or both, to form a composite with reinforced properties. The culture is added after step e) or to the composite in step d).

In a preferred embodiment, the polyurethane in step a) the polyurethane 10-20% w/w, preferably about 17% in respect of the total weight of the four-layer material. The polyurethane layer is preferably at least 45% biobased. In a preferred embodiment, the polyurethane is waterborne polyurethane.

In a preferred embodiment, step b) takes place for 2 minutes at 100° C. In another preferred embodiment, step d) takes place for 1 hour and 30 min at 70° C. In another preferred embodiment, step f) takes place for 2 minutes at 100° C.

The composition of the middle layer in step c) may be adjusted by amending the percentages of its components, in order to vary the softness, flexibility and mechanical resistance of the final four-layer material. This layer constitutes a 20-70% w/w in respect of the total weight of the four-layer material. In a preferred embodiment, the adhesive in step e) is 2-10% w/w, preferably about 7.5% w/w in respect of the total weight of the four-layer material. The adhesive layer is preferably at least 50% biobased. In a preferred embodiment, the adhesive is waterborne polyurethane adhesive. The polyurethane and the adhesive may be any ingredient (polyurethane or adhesive respectively) with the requirement of being solvent free with high percentage of bio-based material.

The textile layer in step e) may be selected among any textile consisting of 100% vegetal origin, such as cotton, seed, coconut, linen or the same. In a preferred embodiment, the textile layer is 100% cotton. The textile layer is 30-50% w/w, preferably about 37% w/w, in respect of the total weight of the four-layer material.

In a fourth aspect, the present invention refers to an article comprising the vegan leather material described above. This article may be a textile product, footwear, leather goods, bookbinding, frames, bags, furniture, watch straps, covers, bracelets, handles, baskets, key rings or masks. The leather of the invention may be used in any object for which leather of animal origin or synthetic leather are used.

In a fifth aspect, the present invention refers to the use of persimmon (Diospyros kaki) for the manufacture of textiles, preferably vegan leather. The use of the material obtained from the persimmon fruit may be combined with polymers as described above for manufacturing a textile with properties and aspect as the real leather.

Despite other leather-type materials of vegetable origin have been disclosed, the choice of persimmon would not be the fruit to be considered by a person skilled in the art due to its intrinsic features. Persimmon lacks the ability to form a 3D matrix that may provide the necessary strength and flexibility in the material, due to the low number of fibers in its composition (approximately 1% w/w). Moreover, this fruit usually has lots of imperfections on its surface due to the variation in color, particle size and lack of surface smoothness. These features teach away the skilled person to use persimmon over other vegetables. The leather-type materials of disclosed herein provides an alternative to known leathers, with less environmental impact and also contributes to circular economy by taken advantage of the excess of persimmon which do not reach the consumer's table. The innovative new material of the invention has been designed to simulate the structure of leather as a mono or multilayer material, thus promoting the circular economy and zero waste of persimmon. Moving towards a more circular economy could deliver benefits such as reducing pressure on the environment, improving the security of the supply of raw materials, increasing competitiveness, stimulating innovation, boosting economic growth and creating jobs. The project is a sustainable solution to the need for the development of a plant-based, eco-friendly leather, a substitute for synthetic and natural leather, minimizing the environmental and health impact of petroleum-derived raw materials.

Unless defined otherwise, all technical and scientific terms used herein have the same meaning as those commonly understood by a person skilled in the field of the invention. Methods and materials similar or equivalent to those described herein can be used in the practice of the present invention. Throughout the description and the claims, the word “comprises”, and its variants are not limiting and therefore are not intended to exclude other technical characteristics, additives, components or steps. The term “comprises” further includes the term “consists of”.

### DESCRIPTION OF FIGURES

The following figures illustrate the present invention and should not be construed as limiting said invention in any way.

FIG. 1. Manufacture of a leather-type material of vegetal origin. A. Gelatinization of corn starch in water. B. Plasticization of the gelatinized corn starch. C. Thermo-plastic gel.

FIG. 2. Layer of the composition in a mold with leather texture. A. Zenith view. B. Lateral view.

FIG. 3. Leather-type material of vegetal origin obtained by the process of the invention.

### EXAMPLES OF THE INVENTION

The invention is illustrated in the examples, as well as in the figures and generic schemes. The substituents and integers used in the follow schemes are as defined in the embodiments of the instant invention, unless otherwise indicated. This section is set forth to aid in an understanding of the invention but should not be construed to limit in any way the invention as set forth in the claims.

### Example 1: Manufacturing of a Vegan Leather from Persimmon and a Polymer Derived from Starch and a Polyol of Vegetable Origin

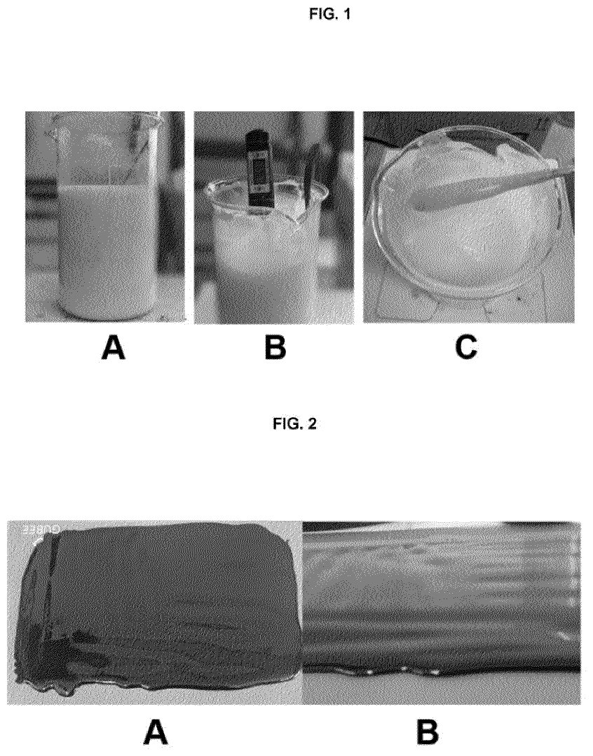

Pieces of brilliant red variety of persimmon from the area Ribera del Xúquer in Valencia (Spain) were collected. The fruits were blended and frozen at −20° C. until its use. The persimmons were defrosted, and the mass was obtained. The fruit mass being used for producing the leather may be persimmon in the form of puree by crushing mechanically the fruit pieces, the residue from a Soxhlet extraction of the persimmon fruit, the fruit pulp or a combination thereof. In the present example persimmon puree was used. The mass was weighted and reserved. 10 g of corn starch were dissolved in 62.5 g of distilled water at 80° C. under continuous stirring until a gel was formed at 70-80° C. The solution was maintained at this temperature for 30 minutes until a nearly translucent gel was formed. FIG. 1A shows the aspect of the cornstarch granules dissolved in water. 5 g of glycerol were added to the solution while stirring and maintaining the heating at 70-80° C. for approximately 10 minutes. At this moment, the gelation process starts, the stirring speed is increased so that the formation of lumps is avoided (for example 2500 rpm), and the mixture was maintained at 80° C. under continuous stirring for 10 minutes with a hand blender. FIG. 1B shows the gelatinized corn starch after glycerol has been added. The stirring continued under heating until the complete gelation of the starch molecules was produced. This moment was identified because the mixture acquired a homogeneous and translucent aspect (FIG. 1C). All the starch granules have completely turned into the translucent gel phase, which was called “glycerol pseudo-plastic starch (GTPS) or plasticized starch. Once the uniform GTPS was produced, this product was weighted. 22 g of persimmon mass was added to 77.5 g of plasticized starch. In this step, 0.5 g of the dye charcoal was also added in order to get a final black color. Addition of the dye only has the purpose of provide the final material the desired color and it is not an essential ingredient in the mixture. The mixture was blended continuously until complete homogenization, obtaining a composite. Complete homogenization is important on order to have a uniform particle size. Once the mixture was fully homogenized, it was added to a mold having a pattern that simulates that of animal leather. FIG. 2 shows a mold with leather texture and the composite.

### Example 2: Manufacturing of a Coated Vegan Leather from Persimmon and a Starch-Derived Polymer

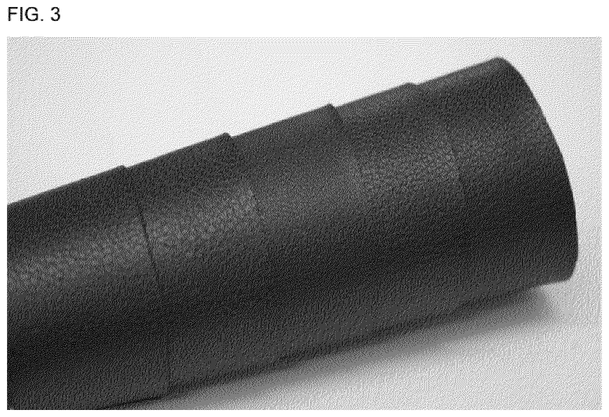

A layer of 100% cotton fiber was placed on top, over the composite obtained in example 1. After assemblance, the sandwich was introduced in a Forced air-drying oven. Afterwards, the sandwich was placed at room temperature for 24 additional hours. Finally, the material was taken out from the mold. FIG. 3 shows the leather-type material obtained after the process. The appearance was identical to leather of animal origin. In order to obtain a protected material with waterproof properties, a layer of coating was added to the material obtained in Example 1. Natural bee wax was mixed with olive oil in 1:1 ratio (w/w) under heating at 40° C. until the wax was fully dissolved. The solution was cooled down and applied uniformly to the leather-type material. After 2 minutes in an oven at 70° C. the excess of coating was removed, and the material was dried again for 2 minutes at 70° C. An additional layer of mixture was added, and the process was repeated.

### Example 3: Manufacturing of a 4-Layer Vegan Leather from Persimmon and a Starch-Derived Polymer

To expand the use of the material of the invention, it was developed a version of the leather-like material formed by 4 layers. Waterborne polyurethane was added to an embossing paper, and it was cured for 2 minutes at 100° C. Waterborne polyurethane is >47% bio based. After this layer was dried, a layer of the material obtained in Example 1 was added on the polyurethane layer (top layer), and both layers were cured for 1 hour and 30 min at 70° C. After drying, an adhesive layer of waterborne polyurethane adhesive was added on the layer comprising persimmon (medium layer) and finally a 100% cotton textile layer were added. The structure with the four layers was cured for 2 minutes at 100° C. Once the material was completely dried, the embossing paper was removed. This material was engineered to simulate the structure of leather as multilayer material. The textile support (100% cotton) fulfils the mechanical function, the middle layer comprising persimmon is the responsible of the feel and softness of the final material, but also of the flexibility and mechanical resistance of the polyurethane upper layer. Table 1 discloses the distribution of the layers of the material and the percentage of biobased element in the final material:

TABLE 1

| | Thickness | | | % Biobased | % biobased |
|---|---|---|---|---|---|
| Layer | (mm) | g/m² | % wt. | per layer | final |
| Polyurethane (top layer) | 0.10 | 89.25 | 17.02 | >47 | >7.99 |
| Persimmon (medium layer) | 0.30 | 197.65 | 37.70 | 100 | 37.70 |
| Adhesive | 0.05 | 40.00 | 7.63 | >50 | >3.81 |
| Textile (bottom layer) | 0.30 | 197.37 | 37.65 | 100 | 37.65 |
| FINAL MATERIAL | 0.75 mm | 524.27 | 100% | | >87.15 |

From this table it may be concluded that the total bio-based content in the material is above 85%.

### Example 4: Characterization of the Layered Vegan Leather

The mechanical properties of the material of Example 3 were compared with commercial materials of animal origin. There were chosen two tests to determine abrasion resistance and colour fastness to cycles of to-and-fro rubbing. the determination of the abrasion resistance was performed by the standard method EN 13520:2001/A1:2004). This method was performed in a Martindale abrasion tester at a testing pressure of 12 Pa. Table 2 shows the result of the assay. The results indicated that the material of the invention passed the abrasion resistance test, as other commercial leather, which makes this material suitable for clothing and manufacturing of goods.

TABLE 2

| Leather type | No turns | Observations | Pass |
|---|---|---|---|
| Invention | 1800 | No visual change | Yes |
| | 3200 | Light removal of coating layer | Yes |
| | 6400 | Moderate removal of coating layer. | Yes |
| | | Dry change in color 4. | |
| Full grain (*) | 1600-6400 | No damage or color loss ≥4 gsr | Yes |
| Nubuck/Split/Suede (*) | 1600 | No damage or color loss ≥4 gsr | Yes |
| Pony skin (*) | 800 | No damage or color loss ≥4 gsr | Yes |

(*) Commercially available

The color fastness was determined according to ISO 11640:2018). This method is referred on how a leather should behave in the test with pieces of standard wool with a given number of forward and backward motions. The change in colour during the test is assessed with a standardized grey scale. Any other visible change or damage of the surface of the leather should be also reported when this test is performed. The value should be A value of 5 it's the best and the greatest grade and any lower value indicates a change in colour. Commercial brands and manufacturers require a value in this test of at least 4 at the end of the cycles. Table 3 shows the results of the test. In this case, the material of the invention had a behaviour similar to the animal leather and at 6400 cycles it showed a grade of 4 and a slight removal of the coating which are both accepted in textile industry.

TABLE 3

| | | | Damp stanning | |
|---|---|---|---|---|
| | | Dry change | change | |
| Leather type | | Stanning in color | in color | Pass |
| Invention | | 5 (150 5 (150 | 5 (50 5 (50 | Yes |
| | | cycles) cycles) | cycles) cycles) | |
| Footwear | UPPER (*) | Foot contact/non- | Foot contact side test: | Yes |
| | | contact side of | 50 cycles, ≥3 on the | |
| | | foot test: 100 | grey scale | |
| Leather | Full grain (*) | 4 (150 cycles) | 4 (30 cycles) | Yes |
| hides | Nubuck/Split/Suede (*) | 3 (100 cycles) | 3 (20 cycles) | Yes |
| | Pony skin (*) | 4 (50 cycles) | 3 (10 cycles) | Yes |

(*) Commercially available

When the leather is for directed to an item in foot contact or non-contact side of foot, the standard is performed at 100 cycles and at 50 cycles with a maximum grade required for a pass of equal or higher to 3 in the grey scale. The results above show the grade of each material after several cycles are the average results. The material of the invention obtained a score of 5 in all tests with 150 cycles instead of 100 in the other materials or 50 cycles instead 10-50 cycles in the other materials. These results indicate that the material of the invention has a very good performance, even better than other commercial leathers. These results show that the performance of the material of the invention comply with two of the most important tests required by natural leather manufacturer and designers.

### Example 5: Manufacturing of Vegan Leather from Persimmon and PU Formed from Isocyanates and Polyols of Vegetable Origin

The persimmon pure was obtained as described in Example 1.48 g of this persimmon mass was mixed with 46 g of a PU of natural origin and the mixture was stirred. During the stirring, 5 g of soja oil and 1 g of a natural pigment were added to the mixture, and the stirring was maintained for 5-10 min. For the manufacturing of the multilayer vegan leather material, a mixture of waterborne PU with additives is added on an embossing paper which gives the texture to the final top layer, obtaining a layer with a thickness of less than 200 micrometers. This layer is dried by passing through ventilated ovens at a T above 100° C. for a couple of minutes, to obtain the top layer. Then, the mixture based on persimmon mass previously obtained is added on this dried top layer. The application is with continuous and slow flow and can be with various thicknesses, depending on the interest of the thickness of the final sample. It is dried by passing it through ventilated ovens at a T above 100° C. A bio-based PU adhesive is prepared and spread on the dried persimmon layer together with an organic support, in this case a cotton cloth. The two layers are pressed together and then placed in the ovens for a couple of minutes to dry. Finally, the product is cured in oven at a temperature of 135-140° C. during 3-5 min. In the obtained material, layer (a) represents 11% wt., layer (b) 51% wt., layer (c) 8% wt. and layer (d) 30% wt. in respect to the total weight of the layered material.

### Example 6: Study of the Physical-Mechanical Properties of the Vegan Leather Layered Material from Persimmon and PU

The purpose of this study is the comparison between the properties of the vegan material of the invention and products existing on the market as shown in the following tables:

TABLE 4
standardized test used for measuring each property

| Measured Property | Test | Equivalent |
|---|---|---|
| Thickness (mm) | ISO 17186-A | ASTM D1813 |
| Laminar mass for area unit (g/m²) | UNE-EN ISO 2286-2: 2017 | ASTM D3776 |
| Determination of breaking | UNE-EN ISO 3376: 2011 | |
| strengthand (N/mm²) | | |
| Determination of elongation | UNE-EN ISO 3376: 2011 | |
| strengthand (%) | | |
| Determination of tear resistance (N) | UNE-EN ISO 3377-2: 2016 | ASTM D4704 |
| Determination of transmission of | UNE-EN ISO 14268: 2012 | |
| water vapour (mg/(cm²*h) | | |
| Resistance to flexion (cycles) of the | UNE-EN ISO 5402-1: 2012 | ASTM 6182 |
| coated side | | |
| Colour fastness to artificial light | UNE-EN ISO 105-B02: 2014 | |
| | (Note of 1 to 8) | |
| Determination of the abrasion | UNE-EN ISO 13520:2001/A1: 2004 | ASTM D3886 |
| resistance of fabrics (cycles) | | |
| Colour fastness to cycles of to-and-fro | UNE-EN ISO 11640: 2013 | AATC 8, Flat |
| rubbing | (Note 1 to 5 Dry-Wet) | |

TABLE 5
results for test applied to naturally grown materials

| Measured Property | Leather | Muskin | Kombucha |
|---|---|---|---|
| Thickness (mm) | 1.93 | 6.22 | 0.29 |
| Laminar mass for area unit (g/m²) | | | |
| Determination of breaking strengthand (N/mm²) | 39.5 | 0.2 | 9.7 |
| Determination of elongation strengthand (%) | | | |
| Determination of tear resistance (N) | 82.9 | 0.5 | 5.1 |
| Determination of transmission of water | 4.6 | 10.4 | 0.1 |
| vapour (mg/(cm²*h) | | | |
| Resistance to flexion (cycles) of the coated | 200 | 10,000 | 10,000 |
| side | | | |
| Colour fastness to artificial light | | | |
| Determination of the abrasion resistance of | | | |
| fabrics (cycles) | | | |
| Colour fastness to cycles of to-and-fro | | | |
| rubbing | | | |

TABLE 6
results for test applied to different coated textiles

| | PUR | | | | | | | Vegan leather |
|---|---|---|---|---|---|---|---|---|
| | coat | | | | Teak | | Fruit | of the invention |
| Property | tex. | Desser [symbol] | A [symbol] leskin | V [symbol] | Leaf | N [symbol] works | Leather | ( [symbol] ) |
| Thickness (mm) | 1.37 | 0.88 | 1.14 | 0.95 | 0.57 | 1.065 | 1.05 | 1.32 |
| [symbol] mass for area | | | | | | 453 | | 794 |
| unit (g/m²) | | | | | | | | |
| Determination of | 10.2 | 20.8 | 14 | 9.4 | 12.2 | | 7.74 | 8.27 |
| breaking strengthand | | | | | | | | |
| (N/mm²) | | | | | | | | |
| Determination of | | | | | | | 49.2 | 26.74 |
| elongation | | | | | | | | |
| strengthand (%) | | | | | | | | |
| Determination of tear | 17 | 37.2 | 18.4 | 16.6 | 30.7 | 53.6 | 19.38 | 61.68 |
| resistance (N) | | | | | | | | |
| Determination of | 200,000 | 30,000 | 50,000 | 50,000 | 100 | 100,000 | 10,000 | >300,000 |
| transmission of water | | | | | | | | |
| vapour (mg/(cm²*h) | | | | | | | | |
| Resistance to flexion | | | | | | | | 6-7 |
| (cycles) of the coated | | | | | | | | |
| side | | | | | | | | |
| Colour fastness to | | | | | | 1,300 | | 25,600 |
| artificial tight | | | | | | | | |
| Determination of the | | | | | | 5 | 4 | 5 |
| abrasion resistance of | | | | | | | | |
| fabrics (cycles) | | | | | | | | |
| Colour fastness to | | | | | | 4 | 3 | 4-5 |
| cycles of to-and-fro | | | | | | | | |
| rubbing | | | | | | | | |

[symbol]

indicates data missing or illegible when filed

TABLE 7
results for test applied to non-woven of plant material

| Measured Property | Pinatex | SnapPap |
|---|---|---|
| Thickness (mm) | 1.43 | 0.57 |
| Laminar mass for area unit (g/m²) | | |
| Determination of breaking strengthand | 4.5 | 24.9 |
| (N/mm²) | | |
| Determination of elongation strengthand (%) | | |
| Determination of tear resistance (N) | 31 | 7.5 |
| Determination of transmission of water vapour | 2.5 | 10.3 |
| (ma/(cm²*h) | | |
| Resistance to flexion (cycles) of the coated | 150,000 | 5,000 |
| side | | |
| Colour fastness to artificial light | | |
| Determination of the abrasion resistance of | | |
| fabrics (cycles) | | |
| Colour fastness to cycles of to-and-fro rubbing | | |

Regarding the thickness, it can be seen that there are products which have a greater thickness and other products less, so the vegan leather of the invention is in line of similar products, 36% of the competition are with values above and 64% below.

The laminar mass is a very important property in terms of physical parameters of the products, and it depends on the textile substrate used and the intermediate layer of persimmon deposited.

The tensile strength test evaluates the resistance of the fabric itself when subjected to a certain force until it breaks. As can be seen in the results, the breaking strength value of the vegan leather of the invention is also in line with many of the results of the competition: 45% of the competition are with values above and 55% below. The resistance to elongation can only be compared with that obtained by Fruit Leather. As can be seen in this case, the value of the fruit leather is higher, although a value of 26.74% obtained by the vegan leather of the invention is already a more than acceptable value for the clothing market that is the market that most requires this property.

The tear resistance is a property that has a greater importance in the market of fashion clothing, upholstery, contract and footwear. In this case the value obtained by the vegan leather of the invention is much higher than the rest of the products, only being surpassed by that of natural skin.

The test of water vapor permeability determines the breathability of the product, which is a relevant property in the clothing market. The value of breathability compared to natural skin is 85% lower although, compared to the rest of the products, 45% is with higher values and 55% with lower values, so it can be said that the vegan leather of the invention is in line with the results of the other commercial products.

The results obtained in the flexural strength test are very favorable for the vegan leather of the invention, since they are higher than the values of the other products, being at the same level as a natural animal skin.

This color fastness to artificial light test determines the resistance of the products to color degradation by continuous exposure to artificial light, having this property a greater impact on the automotive and contract markets.

The vegan leather of the invention was only compared with Fruit Leather and can be seen that the values for the vegan leather of the invention are clearly between 125-150% in terms of color resistance. According to Standard UNE-EN 14465:2004/A1 within the levels of behavior from A to E, the vegan leather of the invention would be at a level A, which is very favorable for the upholstery, automotive and contract market.

The abrasion resistance property has greater incidence in the markets of footwear or upholstery. The value of this property was only measured for the vegan leather of the invention and, according to Standard UNE-EN 14465:2004/A1 within the levels of behavior from A to E, this product would be at a level B, which is very favorable for the upholstery market.

1. A composition for vegan leather comprising persimmon (Diospyros kaki) and a polymer derived from a polyol of vegetable origin.

2. The composition of claim 1, wherein the persimmon represents between 20-60% wt. in respect of the total weight of the composition and the polymer represents between 40-80% wt. in respect of the total weight of the composition.

3. The composition of claim 1, wherein the persimmon represents between 30-40% wt. in respect of the total weight of the composition and the polymer represents between 60-70% wt. in respect of the total weight of the composition.

4. The composition of claim 1, wherein the polymer is a plasticized starch derived from starch and a glycerol of vegetable origin, preferably the starch is corn starch.

5. The composition of claim 1, wherein the polymer is a polyurethane derived from vegetable polyols.

6. The composition according to claim 1, which further comprises between 0.1-1% wt. in respect of the total weight of the composition of a dye of vegetal origin.

7. The composition according to claim 1, which further comprises between 1-10% wt. in respect of the total weight of the composition of a vegetal oil selected from sesame oil, canola oil, sunflower oil, soybean oil, peanut oil, olive oil, corn oil, bean oil, grapeseed oil, jojoba oil, palm oil, cotton seed oil, almond oil, safflower oil, walnut oil, avocado oil, rice bran oil, and flaxseed oil.

8. The composition according to claim 1, which further comprises between 0.5-2% wt. in respect of the total weight of the composition of an additive selected from thickeners, crosslinkers, stabilizers.

9. A vegan leather material comprising the composition according to claim 1.

10. The material of claim 9, which is a layered material comprising the following layers:
a) a top layer comprising waterborne polyurethane,
b) a second layer comprising the composition according to claim 1
c) a third layer comprising a waterborne polyurethane with adhesive properties, and
d) optionally, a fourth layer which is a textile layer.

11. The material of claim 10, wherein the layer (a) represents between 10-20% wt. in respect of the total weight of the material, and/or the layer (b) represents between 20-70% wt. in respect of the total weight of the material, and/or the layer (c) represents between 2-10% wt. in respect of the total weight of the material and/or the layer (d) represents between 30-50% wt. in respect of the total weight of the material.

12. The material of claim 10, wherein the layer (a) is coated with a composition comprising a wax and a vegetable oil.

13. The material of claim 12, wherein the wax and the vegetable oil are in 1:1 ratio.

14. The material of claim 12, wherein the wax is selected from bee wax, montan wax, candelilla wax and carnauba wax.

15. The material of claim 11, wherein the vegetable oil is selected from sesame oil, canola oil, sunflower oil, soybean oil, peanut oil, olive oil, corn oil, bean oil, grapeseed oil, jojoba oil, palm oil, cotton seed oil, almond oil, safflower oil, walnut oil, avocado oil, rice bran oil, and flaxseed oil.

16. The material of claim 11, wherein the layer (a) has a thickness of 0.05-0.30 mm, and/or the layer (b) has a thickness of 0.20-1.50 mm, and/or the layer (c) has a thickness of 0.05-0.20 mm, and/or the layer (d) has a thickness of 0.20-0.50 mm.

17. A process for obtaining the layered material of claim 10 comprising the following steps:
a) depositing a first layer of waterborne polyurethane onto a support;
b) drying the polyurethane of step a) at a temperature between 100-120° C. for 1-10 minutes;
c) adding to the dry polyurethane of step b) a layer of the composition comprising persimmon;
d) drying of the two layers at a temperature between 70-150° C. for 5 minutes to 2 hours;
e) adding a third layer of waterborne polyurethane with adhesive properties on the layer comprising persimmon dried in step d), and optionally adding a textile layer above the adhesive layer of step e);
f) drying at a temperature between 100-150° C. for 1-5 minutes;

18. The process according to claim 17, wherein the support of step a) presents a pattern to impress said pattern onto the top layer (a).

19. An article comprising the vegan leather material according to claim 10.

20. The article of claim 19 which is selected from a textile product, a footwear product, a leather good, a bookbinding, a frame, a bag, furniture, a watch strap, a cover, a bracelet, a handle, a basket, a key ring or a mask.

21. (canceled)
